(19) United States
(12) Patent Application Publication
(10) Pub. No.: US 2017/0240078 A1
(43) Pub. Date: Aug. 24, 2017

(54) SEAT AIR CONDITIONING SYSTEM

(71) Applicant: DENSO CORPORATION, Kariya-city, Aichi-pref. (JP)

(72) Inventors: Fumiya ISHII, Kariya-city (JP); Masafumi KAWASHIMA, Kariya-city (JP)

(73) Assignee: DENSO CORPORATION, Kariya-city, Aichi-pref. (JP)

(21) Appl. No.: 15/125,213

(22) PCT Filed: Mar. 12, 2015
(86) PCT No.: PCT/JP2015/001392

§ 371 Date: Sep. 12, 2016

(30) Foreign Application Priority Data
Mar. 17, 2014 (JP) 2014-053508

(51) Int. Cl. B60N 2/56; B60N 2/70

(52) U.S. Cl. CPC B60N 2/5642; B60N 2/5678; B60N 2/70; B60N 2/5657

(57) ABSTRACT

A seat air conditioning system includes: a seat pad that constitute a seat on which a user is seated and that is resiliently deformed to support the user on a surface-side of the seat pad, the seat pad including ventilation passages that open respectively on the surface-side; a surface cover that has air permeability and is disposed to cover the surface-side of the seat pad; an air outlet at which airs blown out respectively from the ventilation passages meet; and a blower that includes a suction port located on a rear surface-side of the seat pad to be connected to the air outlet and that suctions air from the surface cover-side through the ventilation passages, the air outlet, and the suction port. The air blown out from the air outlet is straightened to flow into the suction port.

### CROSS REFERENCE TO RELATED APPLICATION

This application is based on Japanese Patent Application No. 2014-53508 filed on Mar. 17, 2014, the disclosure of which is incorporated herein by reference.

### TECHNICAL FIELD

The present disclosure relates to a seat air conditioning system.

### BACKGROUND ART

For a seat air conditioning system, there is conventionally known a blow-out type system in which ventilation passages are provided for a seat pad that constitutes a seat, and air is blown from a blower through the ventilation passages toward the surface of the seat (see Patent Document 1).

### PRIOR ART DOCUMENT

### Patent Document

Patent Document 1: JP2011-130977A

The seat air conditioning system has recently been required to improve its performance. For example, improvement in air volume performance and the change from the blow-out type to a suction type have been considered to improve comfortableness.

As illustrated in FIG. 14, the inventors considered a seat air conditioning system 1 of a suction type in which a suction port 2a of a blower 2 is connected directly to an outlet part 3a of ventilation passages 3 of a seat pad 4.

The outlet part 3a of the ventilation passages 3 is the part at which airflows meet from the ventilation passages 3. Thus, it is revealed that the following issue is raised. Specifically, the air flowing into the blower 2 forms uneven flows between the suction port 2a of the blower 2 and the outlet part 3a of the ventilation passages 3 in the seat pad 4 to make noise (see FIG. 15). The arrows in FIG. 15 indicate air flows.

### SUMMARY OF INVENTION

The present disclosure addresses the above issues. Thus, it is an objective of the present disclosure to restrict noise generation when air flows from ventilation passages in a seat pad into a suction port of a blower in a seat air conditioning system.

To achieve the above objective, a seat air conditioning system in an aspect of the present disclosure includes: a seat pad that constitute a seat on which a user is seated and that is resiliently deformed to support the user on a surface-side of the seat pad, the seat pad including a plurality of ventilation passages that open respectively on the surface-side; a surface cover that has air permeability and is disposed to cover the surface-side of the seat pad; an air outlet at which airs blown out respectively from the plurality of ventilation passages meet; and a blower that includes a suction port located on a rear surface-side of the seat pad to be connected to the air outlet and that suctions air from the surface cover-side through the plurality of ventilation passages, the air outlet, and the suction port. The air blown out from the air outlet is straightened to flow into the suction port.

In this aspect, the airs blown out respectively from the plurality of ventilation passages are straightened to flow into the suction port. Consequently, noise generation when air flows into the suction port of the blower from the plurality of ventilation passages can be limited.

### BRIEF DESCRIPTION OF DRAWINGS

The above and other objects, features and advantages of the present disclosure will become more apparent from the following detailed description made with reference to the accompanying drawings. In the drawings:

FIG. 1 is a general view illustrating a seat air conditioning system in accordance with a first embodiment;

FIG. 2 is an exploded view illustrating the seat air conditioning system of the first embodiment;

FIG. 3 is a sectional view illustrating the seat air conditioning system of the first embodiment;

FIG. 4 is a perspective view illustrating a blower in FIG. 1;

FIG. 5 is an exploded view illustrating the blower in FIG. 1;

FIG. 6 is a sectional view taken along a line VI-VI in FIG. 4;

FIG. 7 is a diagram illustrating an arrangement of blades of the blower in FIG. 1;

FIG. 8 is a cross-sectional view taken along a line VIII-VIII in FIG. 2;

FIG. 9 is a diagram illustrating airflows flowing into the blower in FIG. 1;

FIG. 10 is a sectional view illustrating a seat air conditioning system in accordance with a second embodiment;

FIG. 11 is a sectional view illustrating a seat air conditioning system in accordance with a third embodiment;

FIG. 12 is a sectional view illustrating a seat air conditioning system in accordance with a fourth embodiment;

FIG. 13 is a sectional view illustrating a seat air conditioning system in accordance with a fifth embodiment;

FIG. 14 is a sectional view illustrating a seat air conditioning system in a comparative example; and

FIG. 15 is a cross-sectional view taken along a line XV-XV in FIG. 13.

### EMBODIMENTS FOR CARRYING OUT INVENTION

Embodiments will be described below with reference to the accompanying drawings. For the same or equivalent component in the following embodiments, the same corresponding reference numeral is used in the drawings for simplified description.

### First Embodiment

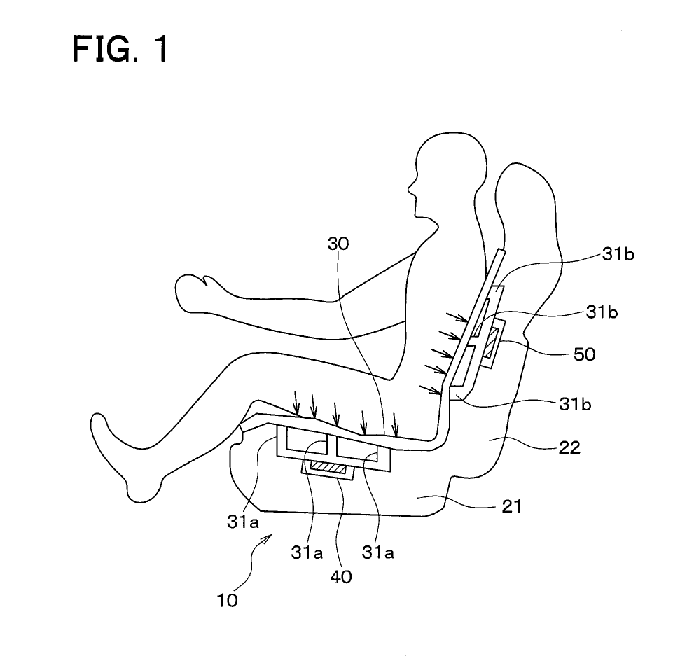

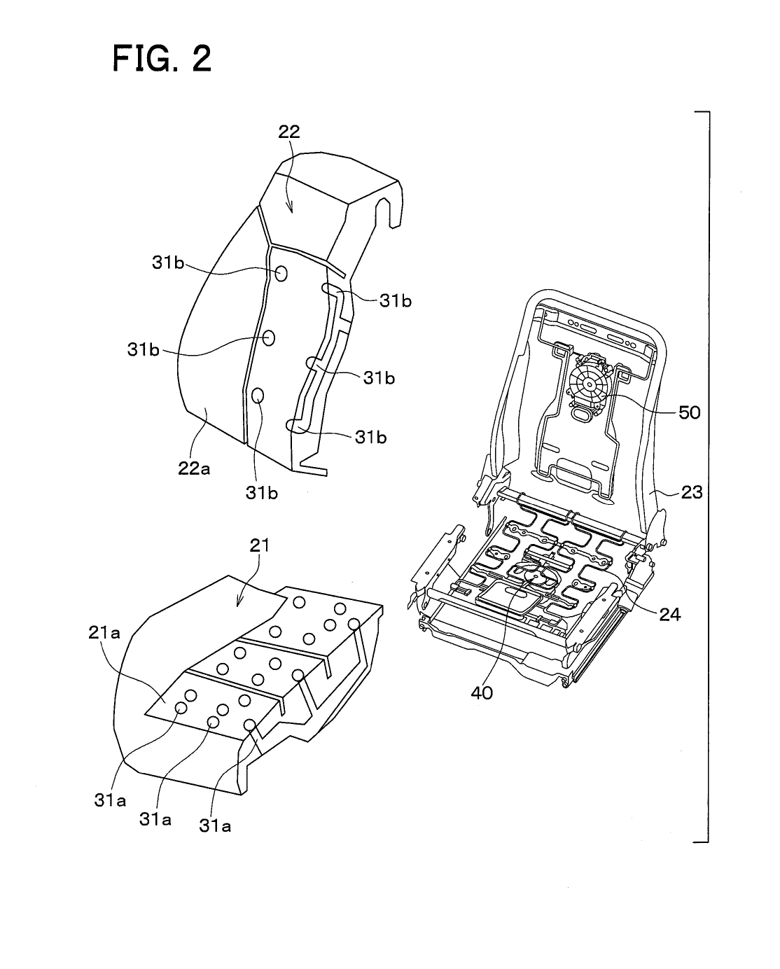

FIGS. 1 and 2 illustrate a first embodiment of a seat air conditioning system 10 for a vehicle that applies the present disclosure to an automobile.

As illustrated in FIG. 1, the seat air conditioning system 10 for the vehicle includes a vehicle seat 20, a surface cover 30, and blowers 40, 50. As illustrated in FIGS. 1 and 2, the vehicle seat 20 includes a seat cushion 21, a seat back 22, a seat frame 23, and a seat wire 24. The seat cushion 21 supports thighs and buttocks of an occupant (user).

The seat cushion 21 includes a seat pad that is resiliently deformed to support the occupant on a surface 21a side. The seat pad includes a resilient member such as urethane foam. The seat cushion 21 is supported by the seat frame 23 via the seat wire 24. The seat frame 23 is a member that constitutes the framework of the seat 20. Ventilation passages 31a are formed in the seat cushion 21. Each of the ventilation passages 31a opens on the surface 21a-side of the seat cushion 21. The seat wire 24 is configured as a resilient member, and is supported by the seat frame 23.

The seat back 22 supports the occupant's back. The seat back 22 includes a seat pad that is resiliently deformed to support the occupant on a surface 22a side. The seat back 22 is supported by the seat frame 23. Ventilation passages 31b are formed in the seat back 22. Each of the ventilation passages 31b opens on the surface 22a-side of the seat back 22. The surface cover 30 is a sheet such as a non-woven fabric having air permeability. The surface cover 30 is disposed to cover the surface 21a of the seat cushion 21 and the surface 22a of the seat back 22.

The blower 40 constitutes an air-blowing system of the seat cushion 21 together with the ventilation passages 31a, and draws air through the ventilation passages 31a from the surface 21a-side of the seat cushion 21. The blower 40 is disposed on the rear surface-side of the seat cushion 21.

The blower 50 constitutes an air-blowing system of the seat back 22 together with the ventilation passages 31b, and draws air through the ventilation passages 31b from the surface 22a-side of the seat back 22. The blower 50 is disposed on the rear surface-side of the seat back 22. The blowers 40, 50 are supported by the seat frame 23.

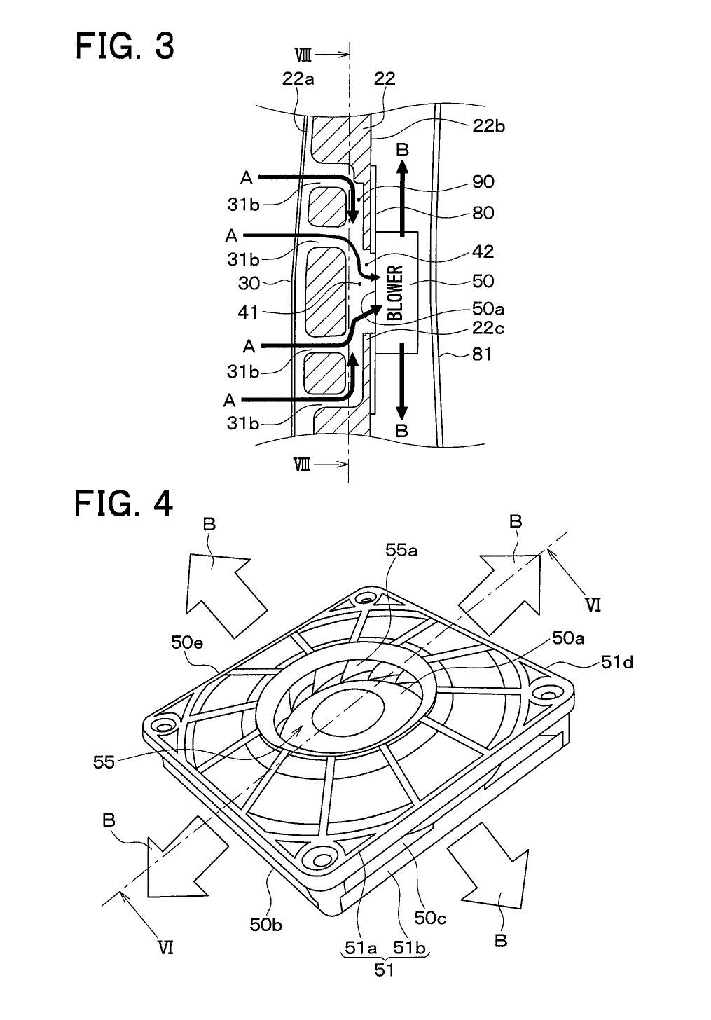

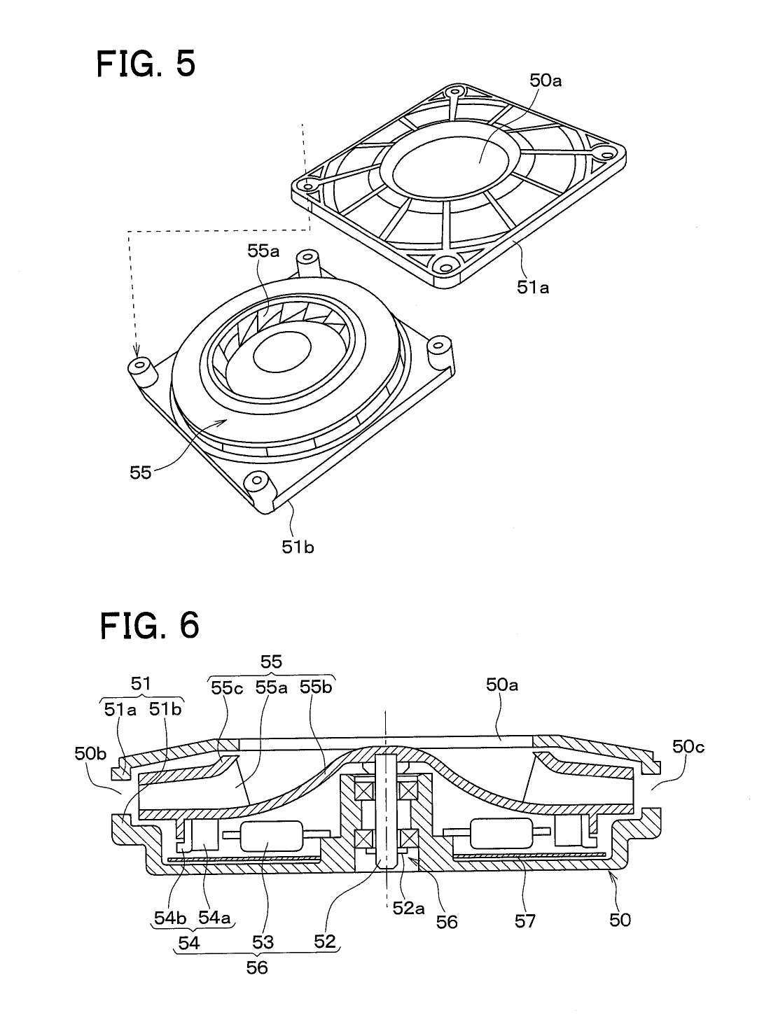

In the present embodiment, the air-blowing system of the seat cushion 21 and the air-blowing system of the seat back 22 are substantially similar. Of the air-blowing system of the seat cushion 21 and the air-blowing system of the seat back 22, the air-blowing system of the seat back 22 will be described below as a typical example with reference to FIGS. 3 to 9.

The seat back 22 in FIG. 3 includes an outlet passage 90. The outlet passage 90 is formed to be connected to the ventilation passages 31b and to extend in the direction of the surface perpendicular to the axial direction of the blower 50. The outlet passage 90 is formed in a circular shape with a rotation shaft 52 as its center when viewed from one axial side of the rotation shaft 52.

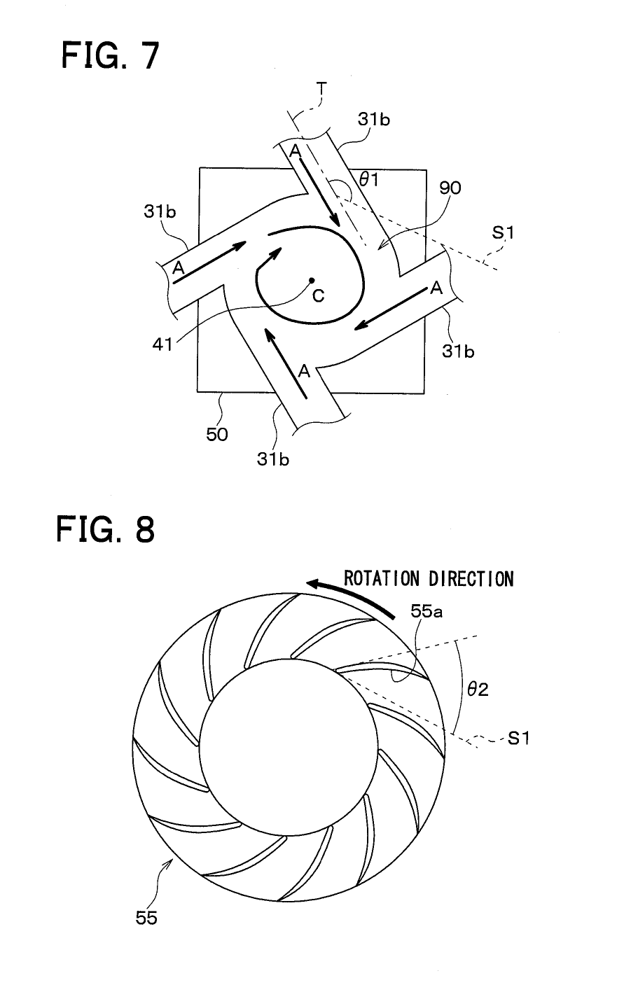

Each of the ventilation passages 31b is connected to the radially outward part of the outlet passage 90 with the rotation shaft 52 as the center. The ventilation passages 31b are arranged at the same intervals in the circumferential direction with the rotation shaft 52 as the center. In the example in FIG. 7, the four ventilation passages 31b are connected to the outlet passage 90, and the four ventilation passages 31b are arranged side by side at intervals of 45 degrees in the circumferential direction.

The angle θ1 formed in the rotation direction between the direction of a tangent line S1 that is tangent to the circumferential direction with the rotation shaft 52 as the center, and each of the ventilation passages 31b is set at the same angle. The angle θ1 of the present embodiment is an angle that satisfies 90°≦θ1<180°. The angle θ1 is an angle viewed from the axial direction of the rotation shaft 52, and indicates an angle made in the rotation direction between a central line T of each of the ventilation passages 31b in its width direction and the direction of the tangent line S1. Thus, the angle θ1 is an angle that is made in the rotation direction between the flow direction of air flowing through each of the ventilation passages 31b and the direction of the tangent line S1.

An air outlet 41 is formed at the part of the outlet passage 90 that is opposed to a suction port 50a of the blower 50. Thus, as illustrated in FIG. 3, the air outlet 41 is opposed to the suction port 50a of the blower 50.

A formation part 22c that defines a chamber 42 is provided at the seat back 22 of the present embodiment. The chamber 42 is an air passage that is formed between the air outlet 41 of the outlet passage 90 and the suction port 50a of the blower 50.

The blower 50 is a turbofan that blows out the air, which is drawn from the suction port 50a, radially outward of the rotation shaft 52 (see FIG. 6). Specifically, the blower 50 includes a case 51, the rotation shaft 52, a stator coil 53, a rotor 54, and a centrifugal multiblade fan 55 as illustrated in FIGS. 4 to 6. The case 51 is formed in a flat shape by an upper case part 51a and a lower case part 51b. The suction port 50a is formed on the upper surface of the upper case part 51a. The suction port 50a is disposed on the one axial side of the rotation shaft 52. The rotation shaft 52 is supported by the lower case part 51b via a bearing 52a in the case 51.

Blow-out ports 50b, 50c, 50d, and 50e are formed respectively on four side surfaces of the case 51. The stator coil 53 is disposed radially outward of the rotation shaft 52 in the case 51. The stator coil 53 outputs a rotating magnetic field to the rotor 54. The stator coil 53 is supported by the case 51. The rotor 54 includes a permanent magnet 54a and a ring 54b. The permanent magnet 54a is supported by the centrifugal multiblade fan 55 via the ring 54b. The rotation shaft 52, the stator coil 53, and the rotor 54 constitute an electric motor 56.

The centrifugal multiblade fan 55 includes blades 55a, a bottom plate 55b, and a ring member 55c. The blades 55a are arranged side by side at the same intervals in the circumferential direction with the rotation shaft 52 as the center. The direction in which the air outlet 41 and the suction port 50a are aligned is the axial direction of the rotation shaft 52. The bottom plate 55b supports the blades 55a on the other axial side of the rotation shaft 52. The bottom plate 55b is formed in a generally circular plate-shape when viewed from the one axial side of the rotation shaft 52. The bottom plate 55b is inclined toward the other axial side in the direction radially outward from the rotation shaft 52. The bottom plate 55b is supported by the rotation shaft 52. The blades 55a are accordingly supported by the rotation shaft 52 via the bottom plate 55b. The ring member 55c is formed in a ring shape with the rotation shaft 52 as its center. The ring member 55c supports one side of the blades 55a in the axial direction.

The centrifugal multiblade fan 55 of the present embodiment is configured as a turbofan in which the radially outward parts of the blades 55a are directed on the opposite side from the rotation direction (i.e., backward). The reference numeral 80 in FIG. 3 indicates a lumbar support, and the reference numeral 81 in FIG. 3 indicates a back board. The reference numeral 57 in FIG. 6 indicates a basal plate.

An angle θ2 formed in the rotation direction between each of the blades 55a, and the direction of the tangent line S1 that is tangent to the circumferential direction with the rotation shaft 52 as the center radially inward with the rotation shaft 52 as the center is set at the same angle. The angle θ2 of the present embodiment is an angle that satisfies 20°<θ2<80° Thus, the angle θ2 and the angle θ1 are different from each other. More specifically, the angle θ2 and the angle θ1 have a relationship that satisfies (θ1-θ2)≧90°.

The operation of the air-blowing system of the seat back 22 of the present embodiment will be described below.

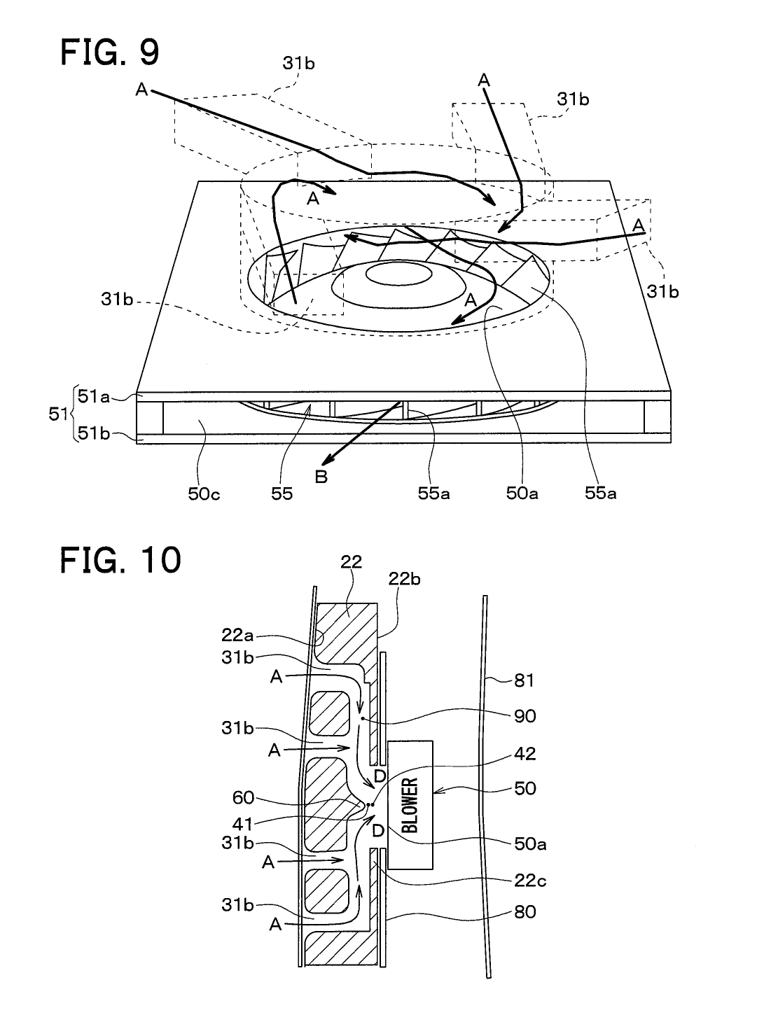

First, the electric motor 56 rotates the centrifugal multiblade fan 55 in a direction C in FIG. 7 via the rotation shaft 52. Air is accordingly drawn from the surface 22a-side of the seat back 22 through the ventilation passages 31b as indicated by arrows A in FIG. 3. This drawn air passes through the ventilation passages 31b, and then merges together in the outlet passage 90. Subsequently, this collected air is suctioned into the blower 50 from the air outlet 41 of the outlet passage 90 through the suction port 50a. After that, the air is blown out radially outward of the rotation shaft 52 through between two adjacent blades 55a of the blades 55a as indicated by an arrow B in FIG. 9. This blown-out air is blown out through blow-out ports 53a, 53b, 53c, 53d.

As described above, the angle θ2 and the angle θ1 are different from each other. Thus, each of the blades 55a guides the air, which is suctioned through the suction port 50a, in a radially outward direction. Consequently, the air blown out respectively from the ventilation passages 31b is straightened between the air outlet 41 and the suction port 50a to flow into the suction port 50a.

In the above-described present embodiment, the angle θ1 of each of the ventilation passages 31b and the angle θ2 of each of the blades 55a are different from each other. Thus, each of the blades 55a guides the air, which is suctioned through the suction port 50a, in a radially outward direction. As a consequence of this, the air blown out respectively from the ventilation passages 31b is straightened between the air outlet 41 and the suction port 50a to flow into the suction port 50a. Hence, the air is suctioned with an ideal air flow from the air outlet 41 into the suction port 50a of the blower 50. Therefore, noise generation when the air flows into the suction port 50a of the blower 50 from the air outlet 41 can be limited without increasing the size of the seat back (i.e., seat pad) 22.

### Second Embodiment

The above first embodiment has explained the example in which each of the blades 55a guides the air, which is suctioned through the suction port 50a, in a radially outward direction to straighten the air blown out from the ventilation passages 31b. Alternatively, the present embodiment will explain the example to straighten the air blown out from ventilation passages 31b by a guide part.

FIG. 10 is a sectional view illustrating a seat back 22 and a blower 50 of a seat air conditioning system 10 for a vehicle of the present embodiment. In the present embodiment, the part of the seat back 22 that is opposed to a suction port 50a of the blower 50 includes a guide part 60. The guide part 60 is a blow-out guide that is located at the seat back 22 on the extension line of a rotation shaft 52 and that is formed to project from the seat back 22 toward the suction port 50a.

In the present embodiment configured as above, when an electric motor 56 rotates a centrifugal multiblade fan 55, air is drawn in through the ventilation passages 31b from a surface 22a-side of the seat back 22. This drawn air meets in an outlet passage 90 after passing through the ventilation passages 31b. In this case, this guide part 60 guides the airflows, which are blown out respectively from the ventilation passages 31b, from the outlet passage 90 toward the suction port 50a. Thus, the airflows, which are blown out respectively from the ventilation passages 31b, are straightened without collision to flow into the suction port 50a through an air outlet 41 and a chamber 42. After that, the air is blown out radially outward of the rotation shaft 52 through between two adjacent blades 55a of the blades 55a.

In the above-described present embodiment, the guide part 60 of the seat back 22 guides the airflows blown out from the ventilation passages 31b from the outlet passage 90 toward the suction port 50a. The airflows blown out from the ventilation passages 31b are accordingly straightened to flow into the suction port 50a. Thus, the noise generation when the air flows into the suction port 50a of the blower 50 from the air outlet 41 can be limited without greatly modifying the structure of the ventilation passage in the seat back (seat pad) 22.

In the present embodiment, the airflows, which are blown out respectively from the outlet passage 90-side, are guided by the guide part 60, and the air flows into the suction port 50a of the blower 50. Thus, the collision of the airs blown out from the ventilation passages 31b near the air outlet 41 can be averted. Therefore, the generation of collision noise due to the collision of airflows can be obviated.

### Third Embodiment

The present embodiment will explain the example in which the size of the chamber 42 in the axial direction in the above first embodiment is increased to straighten the airflows in the chamber 42.

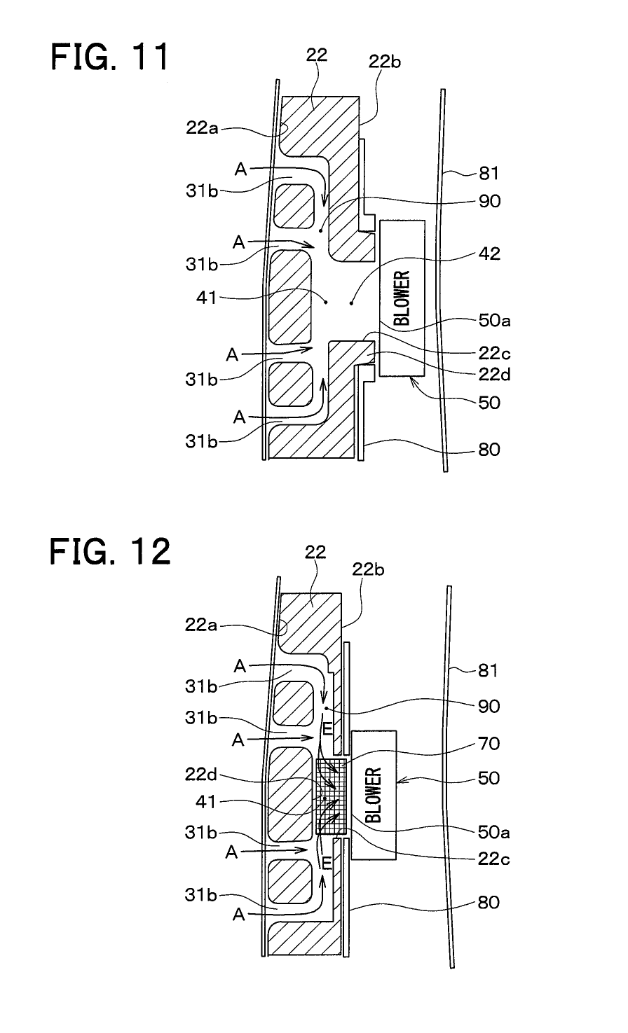

FIG. 11 is a sectional view illustrating a seat back 22 and a blower 50 of a seat air conditioning system 10 for a vehicle of the present embodiment.

A formation part 22c of the seat back 22 of the present embodiment that defines the chamber 42 includes an annular projecting part 22d. The annular projecting part 22d is formed in an annular shape that projects from a rear surface 22b of the seat back 22 toward a suction port 50a and that surrounds the suction port 50a. Consequently, the size of the chamber 42 in the axial direction in the present embodiment can be made longer than the size of the chamber 42 in the axial direction in the above first embodiment.

In the above-described present embodiment, when an electric motor 56 rotates a centrifugal multiblade fan 55, the airs drawn from a surface 22a-side of the seat back 22 through ventilation passages 31b meet in an outlet passage 90. This collected air flows into the suction port 50a through an air outlet 41 of the outlet passage 90 and the chamber 42.

The airs blown out from the ventilation passages 31b are aligned when passing through the chamber 42 to flow into the suction port 50a. Thus, the noise generation when the air flows into the suction port 50a of the blower 50 from the air outlet 41 can be limited.

The present embodiment can straighten the air blown out from the air outlet 41 by the chamber 42 to flow the air into the suction port 50a. Thus, this can allow design flexibility of the structure of the ventilation passage in the seat back (seat pad) 22.

The above third embodiment has explained the example in which the size of the chamber 42 in the axial direction is increased to straighten the airflows between the air outlet 41 and the suction port 50a. Alternatively, the size of the chamber 42 in a direction perpendicular to its axial direction (i.e., cross-sectional area perpendicular to the axial direction) may be increased.

### Fourth Embodiment

The above first embodiment has explained the example in which each of the blades 55a guides the air, which is suctioned through the suction port 50a, in a radially outward direction to straighten the air blown out from the ventilation passages 31b. Alternatively, the present embodiment will illustrate that a straightening member for ordering the airs blown out from ventilation passages 31b is disposed between an air outlet 41 and a suction port 50a.

FIG. 12 is a sectional view illustrating a seat back 22 and a blower 50 of a seat air conditioning system 10 for a vehicle of the present embodiment.

In the present embodiment, a straightening member 70 is disposed between a surface 22d of the seat back 22 that is opposed to the suction port 50a, and the suction port 50a. The straightening member 70 includes a wall that defines passages through which air flows in the axial direction of a rotation shaft 52, and is a three-dimensional knitted fabric with the wall formed from fiber. The straightening member 70 gives pressure loss to the flow of air flowing in the direction crossing the axial direction by the wall that defines the passages. FUSION (Registered Trademark) by Asahi Kasei Fibers Corporation can be used for the three-dimensional knitted fabric.

In the above-described present embodiment, when an electric motor 56 rotates a centrifugal multiblade fan 55, the airs drawn from a surface 22a-side of the seat back 22 through the ventilation passages 31b meet on the straightening member 70-side in an outlet passage 90. This collected air flows into the suction port 50a through the passages of the straightening member 70.

The straightening member 70 causes pressure loss in the flow of air that is blown out from the air outlet 41 and that flows in the direction crossing the axial direction. This straightens the air blown out from the air outlet 41 to flow the air into the suction port 50a. Therefore, the noise generation when the air flows into the suction port 50a of the blower 50 from the ventilation passages 31b can be limited.

### Fifth Embodiment

The above fourth embodiment has illustrated that the straightening member 70 is disposed between the surface 22d of the seat back 22, and the suction port 50a. Alternatively, the present embodiment will illustrate that a straightening member 70 is disposed on the rear side of an outlet passage 90.

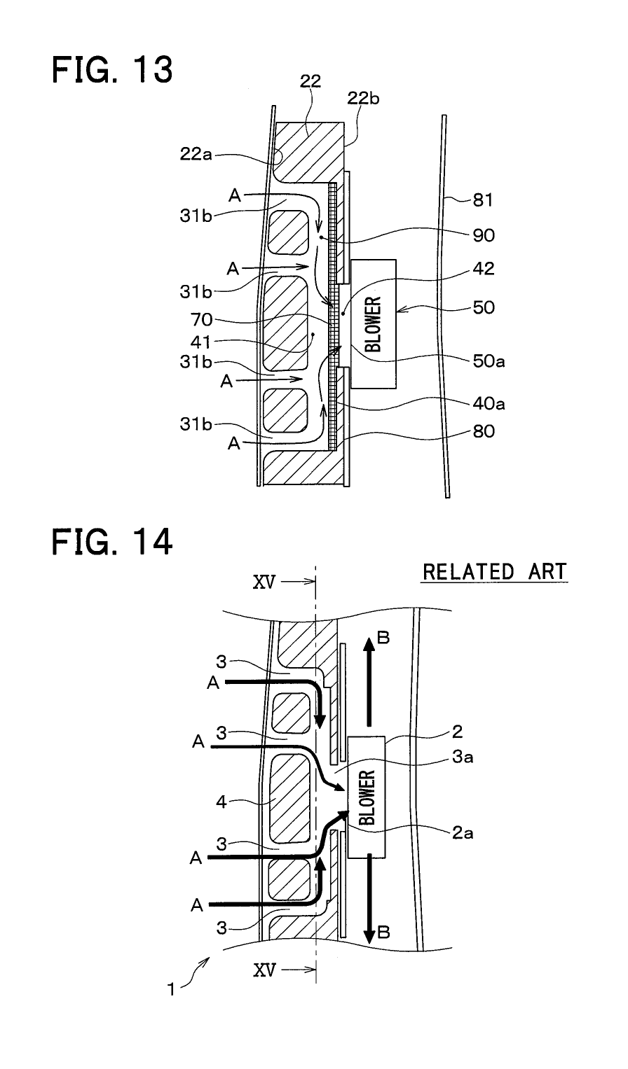

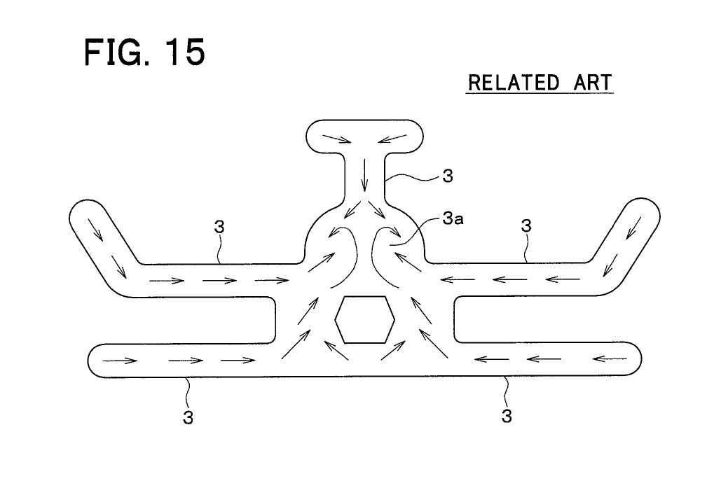

FIG. 13 is a sectional view illustrating a seat back 22 and a blower 50 of a seat air conditioning system 10 for a vehicle of the present embodiment.

The straightening member 70 of the present embodiment is formed in a thin plate-shape, and is formed to cover the rear side of the outlet passage 90. A rear surface 40a of the outlet passage 90 is a surface of the outlet passage 90 on a rear surface 22b-side of the seat back 22.

In the above-described present embodiment, when an electric motor 56 rotates a centrifugal multiblade fan 55, the airs drawn from a surface 22a-side of the seat back 22 through ventilation passages 31b meet in the outlet passage 90. The air flows from an air outlet 41 of the outlet passage 90 into the suction port 50a through the passages of the straightening member 70.

Similar to the above fourth embodiment, the straightening member 70 causes pressure loss in the flow of air that is blown out from the air outlet 41 and that flows in the direction crossing the axial direction. This straightens the air blown out from the air outlet 41 to flow the air into the suction port 50a. Therefore, the noise generation when the air flows into the suction port 50a of the blower 50 from the ventilation passages 31b can be limited.

Additionally, the present embodiment causes the pressure loss in the flow of air that flows from the ventilation passages 31b into the outlet passage 90 and that flows in the direction crossing the axial direction. This can decrease the speed of the air flow in the outlet passage 90. Therefore, the generation of an uneven air flow between the air outlet 41 and the suction port 50a can be restrained.

Modifications to the above embodiments will be described below. The above first to fifth embodiments have illustrated that the seat air conditioning system of the present disclosure is applied to an automobile. Alternatively, the seat air conditioning system of the present disclosure may be applied to a mobile body (e.g., airplane, train) other than an automobile.

The above first to fifth embodiments have illustrated that the turbofan (centrifugal multiblade fan) is configured as a blower. Alternatively, a centrifugal multiblade fan (e.g., sirocco fan) other than the turbofan may be used as the blower of the present disclosure. Or, for example, an axial flow fan other than the centrifugal multiblade fan may be used as the blower of the present disclosure.

The above first to fifth embodiments have illustrated that the angle θ2 and the angle θ1 have a relationship that satisfies (θ1-θ2)≧90°. Additionally, the angle θ2 and the angle θ1 do not necessarily have a relationship that satisfies (θ1-θ2)≧90° as long as the angle θ2 and the angle θ1 are different angles from each other.

The present disclosure is not limited to the above embodiments, and can be modified appropriately without departing from the scope of the disclosure.

Moreover, the above embodiments are not mutually unrelated, and can be combined appropriately except when the combination is obviously impossible. For example, the first embodiment and, any one embodiment of the second, third, fourth, and fifth embodiments may be combined together. One embodiment of the second and third embodiments, and one embodiment of the fourth and fifth embodiments may be combined together.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A seat air conditioning system comprising:
a seat pad that constitute a seat on which a user is seated and that is resiliently deformed to support the user on a surface side of the seat pad, wherein the seat pad includes a plurality of ventilation passages that open respectively on the surface side;
a surface cover that has air permeability and is disposed to cover the surface side of the seat pad;
an air outlet at which airs blown out respectively from the plurality of ventilation passages meet; and
a blower that includes a suction port located on a rear surface-side of the seat pad to be connected to the air outlet and that suctions air from the surface cover-side through the plurality of ventilation passages, the air outlet, and the suction port, wherein air blown out from the air outlet is straightened to flow into the suction port, wherein:
the blower includes:
a rotation shaft;
a centrifugal multiblade fan that has a plurality of blades, which are arranged side by side in a circumferential direction with the rotation shaft as its center and are supported by the rotation shaft; and
a case that accommodates the centrifugal multiblade fan and has the suction port, which opens on one side of the rotation shaft in its axial direction and on the air outlet-side;
the plurality of blades guide an airflow, which is blown out from the air outlet-side, radially outward of the rotation shaft, so that the airflow, which is blown out from the air outlet-side is straightened to flow toward the suction port; and
θ1 and θ2 are different from each other, where:
θ1 is an angle that is formed in a rotation direction of the rotation shaft between a flow direction of air flowing through each of the plurality of ventilation passages, and a direction of a corresponding tangent line tangent to the circumferential direction; and
θ2 is an angle that is formed in the rotation direction of the rotation shaft between each of the plurality of blades and a direction of a corresponding tangent line tangent to the circumferential direction.

2. (canceled)

3. (canceled)

4. The seat air conditioning system according to claim 1, wherein:
θ1 satisfies 90°<θ1<180°; and
θ2 satisfies 20°<θ2<80°.

5. (canceled)

6. (canceled)

7. A seat air conditioning system comprising:
a seat pad that constitute a seat on which a user is seated and that is resiliently deformed to support the user on a surface-side of the seat pad, wherein the seat pad includes a plurality of ventilation passages that open respectively on the surface-side;
a surface cover that has air permeability and is disposed to cover the surface-side of the seat pad;
an air outlet at which airs blown out respectively from the plurality of ventilation passages meet; and
a blower that includes a suction port located on a rear surface-side of the seat pad to be connected to the air outlet and that suctions air from the surface cover-side through the plurality of ventilation passages, the air outlet, and the suction port, wherein air blown out from the air outlet is straightened to flow into the suction port, wherein the seat pad includes a guide part that guides airflows, which are blown out respectively from the plurality of ventilation passages, from the air outlet-side toward the suction port.

8. The seat air conditioning system according to claim 7, wherein the guide part is formed to project from a part of the seat pad that is opposed to the suction port toward the suction port.

9. A seat air conditioning system comprising:
a seat pad that constitute a seat on which a user is seated and that is resiliently deformed to support the user on a surface-side of the seat pad, wherein the seat pad includes a plurality of ventilation passages that open respectively on the surface-side;
a surface cover that has air permeability and is disposed to cover the surface-side of the seat pad;
an air outlet at which airs blown out respectively from the plurality of ventilation passages meet;
a blower that includes a suction port located on a rear surface-side of the seat pad to be connected to the air outlet and that suctions air from the surface cover-side through the plurality of ventilation passages, the air outlet, and the suction port, wherein a direction in which the air outlet and the suction port are aligned is an alignment direction;
an outlet passage which is defined by the seat pad and to which the plurality of ventilation passages are connected, wherein the outlet passage extends in a direction crossing the alignment direction and includes the air outlet at its part that is opposed to the suction port; and
a straightening member that is provided between the air outlet and the suction port on the rear surface-side of the seat pad to straighten an airflow flowing from the air outlet, by causing pressure loss in a flow of air flowing from the air outlet in the direction crossing the alignment direction before the flow of air flowing from the air outlet in the direction crossing the alignment direction flows into the suction port and to flow the airflow into the suction port.

10. The seat air conditioning system according to claim 9, wherein:
the straightening member is disposed in the outlet passage.

11. The seat air conditioning system according to claim 9, wherein:
the straightening member includes a wall that defines a plurality of passages through which the flow of air flows in the alignment direction; and
the wall straightens air blown out from the air outlet by causing pressure loss in the flow of air flowing in the direction crossing the alignment direction, and flows the air into the suction port.

12. The seat air conditioning system according to claim 11, wherein the straightening member is a three-dimensional knitted fabric with the wall formed from fiber.

13. The seat air conditioning system according to claim 9, wherein the blower includes:
a rotation shaft whose axial direction is the alignment direction;
a centrifugal multiblade fan that has a plurality of blades, which are arranged side by side in a circumferential direction with the rotation shaft as its center and are supported by the rotation shaft; and
a case that accommodates the centrifugal multiblade fan and has the suction port, which opens on one side of the rotation shaft in its axial direction and on the air outlet-side.
